(19) United States
(12) Patent Application Publication
(10) Pub. No.: US 2025/0071644 A1
(43) Pub. Date: Feb. 27, 2025

(54) METHODS AND APPARATUS FOR USER EQUIPMENT ALLOCATION

(71) Applicant: Telefonaktiebolaget LM Ericsson (publ), Stockholm (SE)

(72) Inventors: Athanasios KARAPANTELAKIS, Solna (SE); Maxim TESLENKO, SOLLENTUNA (SE); Konstantinos VANDIKAS, Solna (SE); Lackis ELEFTHERIADIS, Valbo (SE); Karthik R M, CHENNAI (IN); Oleg GORBATOV, Luleå (SE); Amin AZARI, Järfälla (SE); Gökce ALACADAGLI, Hägersten (SE); Juan RAMIRO MORENO, Malaga (ES)

(73) Assignee: Telefonaktiebolaget LM Ericsson (publ), Stockholm (SE)

(21) Appl. No.: 18/684,102

(22) PCT Filed: Oct. 28, 2021
(86) PCT No.: PCT/EP2021/079904

§ 371 Date: Feb. 15, 2024

(51) Int. Cl. H04W 36/16; H04W 36/08

(52) U.S. Cl. CPC H04W 36/165; H04W 36/08

(57) ABSTRACT

Embodiments provide methods and systems for allocation of UEs in communication networks. The method comprises analysing the power consumption of the one or more access nodes, and determining, for a UE, whether the net power consumption of the communications network would be reduced if the allocation of the UE was changed. The method further comprises, if it is determined that the net power consumption of the communications network would be reduced if the allocation of the UE was changed, changing the UE allocation. The method further comprises, if it is determined that the net power consumption of the communications network would not be reduced if the allocation of the UE was changed, retaining the current UE allocation.

### TECHNICAL FIELD

Embodiments of the present disclosure relate to methods and apparatus for allocation of User Equipments, UEs, in a communications network.

### BACKGROUND

In communication networks such as 3rd Generation Partnership Project (3GPP) 4^{th} Generation (4G) or 5^{th} Generation (5G) networks, and networks based on the Institute of Electrical and Electronics Engineers (IEEE) 802.11 standards (commonly referred to as Wi-Fi networks), access to the network may be provided via access nodes. The type of access node used varies between communication networks; for 3GPP networks Radio Base Stations (RBS) are used while for Wi-Fi networks access may be provided via wireless access points (WAP) which may be connected to or form part of a router. In 5G networks access is typically provided by next generation base stations (gNB), 4G networks may use enhanced base stations (eNB). The access nodes may allow UEs, such as mobile devices, Internet of Things (IoT) devices and the like, to access the communication network and exchange data.

Typically, it is necessary for communication networks to support the detachment of UEs from one wireless channel and attachment to another wireless channel, commonly referred to as a handover. Handovers may be required for various reasons, including activation/deactivation of access nodes, movement of UEs between cells of different access nodes, and so on. There exist multiple types of handover, for example; a UE (such as a mobile telephone, Internet of Things, IoT, device, and so on) may switch between different Radio Access Technologies (RATs) in an Inter-RAT handover, and may switch from a cell managed by one RBS to a cell managed by another RBS in an Inter-RBS handover, or from one sector to another sector within the same RBS in an Intra-RBS handover.

In an example of a typical handover processes, a UE receives reference signals from the access node (RBS, access point, and so on) and responds with metrics on signal quality. Signal metrics that may be used include Reference Signal Received Power (RSRP), Reference Signal Received Quality (RSRQ), and so on. Handover decisions may then be made using the signal quality metrics. If the signal quality metrics are consistently below a threshold for some time, then a handover decision is made to handover the UE from the serving access node to a target access node. Handovers may also be enacted for other reasons than signal quality, for example, to balance the load across the network such that a single access node is not tasked with providing access for more UEs than it can support. Handover decisions may be made at an access node or at a further network component, for example, a Core Network Node (CNN).

In addition or alternatively to signal metrics, handover decisions may also be based on UE energy consumption. “A Fuzzy Logic System for Vertical Handover and Maximizing Battery Lifetime in Heterogeneous Wireless Multimedia Networks” by Jailton, J., et al., Wireless Communications and Mobile Computing 2019 (2019), available at https://doi.org/10.1155/2019/1213724 as of 16 Aug. 2021 discusses a handover strategy providing a decision-making support system based on fuzzy logic for saving the energy of mobile devices within an integrated Long Term Evolution (LTE) and Wi-Fi network.

### SUMMARY

Although existing systems may make handover decisions based on energy usage of UEs, there is no consideration of the influence UE handovers may have on the energy usage of access nodes themselves (for example, RBSs or WAPs). In view of the growing number of mobile devices, and also the requirements for large numbers of access points in (for example) 5G networks, a network-side energy efficient handover algorithm may help make mobile network growth more sustainable by reducing the environmental footprint of network operations. This is especially true in the case of 5G networks as radio access network operations typically account for a large percentage of the total power consumption in a telecommunications network. It is commonly understood that 5G radio base stations, whilst more capable (e.g., having more bandwidth, lower latency) than those in earlier generations, consume more power than those in earlier generations, despite efforts to decrease energy consumption. Accordingly, temporarily reducing the power usage of part or all of one or more access nodes may significantly reduce network power consumption overall.

This summary is provided to introduce a selection of concepts in a simplified form that are further described below in the detailed description. This summary is not intended to identify key features or essential features of the claimed subject matter, nor is it intended to be used to limit the scope of the claimed subject matter. For the avoidance of doubt, the scope of the claimed subject matter is defined by the claims.

It is an object of the present disclosure to provide increased power efficiency for networks through control of UE handovers.

Embodiments of the disclosure aim to provide methods and apparatus that alleviate some or all of the problems identified above.

An aspect of the disclosure provides a method for allocation of UEs in a communications network comprising one or more access nodes. The method comprises analysing the power consumption of the one or more access nodes, and determining, for a UE, whether the net power consumption of the communications network would be reduced if the allocation of the UE was changed. The method further comprises, if it is determined that the net power consumption of the communications network would be reduced if the allocation of the UE was changed, changing the UE allocation. The method also comprises' if it is determined that the net power consumption of the communications network would not be reduced if the allocation of the UE was changed, retaining the current UE allocation. By taking into account the power consumption of access nodes when determining whether or not UE handovers should be performed, aspects of the disclosure may allow for improved power efficiency from networks relative to prior art systems. Further, as methods may be implemented using existing network infrastructure (such as existing interfaces and storage space), methods may be performed in existing networks without major modifications.

In embodiments, the method may comprise allocating the UE to a different access node and/or allocating the UE to a different RAT. Accordingly, UEs may be handed over to more power efficient access nodes/RATs, allowing power usage of the network as a whole to be reduced.

In embodiments, the determination of whether or not the net power consumption of the communications network would be reduced if the allocation of the UE was changed may comprise estimating the power consumption due to the handover. The estimate may comprise estimating the power consumption if the handover is performed, and estimating the power consumption if the handover is not performed. Accordingly, the power efficiency of the network may be further improved, and handovers that would result in a net loss in efficiency may be avoided.

In some embodiments, the determination of whether or not the net power consumption of the communications network would be reduced if the allocation of the UE was changed may comprise estimating a traffic profile of the UE and/or a traffic profile of the class of UE and/or a mobility profile of the UE. In this way, the change in the power usage of the network may more accurately be estimated.

In some embodiments, the method may determine, for a plurality of UEs, whether the net power consumption of the communications network would be reduced if the allocations of the plurality of UEs was changed. If it is determined that the net power consumption of the communications network would be reduced if the allocation of the plurality of UEs was changed, the allocation of the plurality of UEs may be changed. In this way, the power efficiency of the network as a whole may be prioritised over the efficiency of services provided to individual UEs, potentially supporting increased network power efficiency. This is particularly the case where, through the movement of UEs, it is possible to hand over all UEs connected to part or all of an access node and subsequently deactivate said part or whole of the access node, typically providing a substantial power efficiency benefit.

In some embodiments the method may further comprising determining whether controlling the UE allocation based on the determined effect on the net power consumption of the communications network has resulted in a negative outcome. Further, if it is determined that negative outcomes have occurred above a predetermined frequency, the method may comprise ceasing control of the UE allocation based on the determined effect on the net power consumption of the communications network. Accordingly, poor performance of the method may be detected and negative outcomes potentially comprising one or more of UE connection loss and termination of existing UE data sessions may be substantially minimised.

A further aspect of the disclosure provides a node for allocation of UEs, in a communications network comprising one or more access nodes, wherein the node comprises processing circuitry and a memory containing instructions executable by the processing circuitry. The node is operable to analyse the power consumption of the one or more access nodes, and determine, for a UE, whether the net power consumption of the communications network would be reduced if the allocation of the UE was changed. The node is further operable, if it is determined that the net power consumption of the communications network would be reduced if the allocation of the UE was changed, to change the UE allocation. The node is also operable, if it is determined that the net power consumption of the communications network would not be reduced if the allocation of the UE was changed, to retain the current UE allocation. The node may provide some or all of the advantages discussed above in the context of the methods.

Further aspects provide systems and computer-readable media comprising instructions for performing the methods set out above.

### BRIEF DESCRIPTION OF DRAWINGS

For a better understanding of the present disclosure, and to show how it may be put into effect, reference will now be made, by way of example only, to the accompanying drawings, in which:

FIG. 1 is a flowchart illustrating a method in accordance with embodiments;

FIG. 2A is a schematic diagram of a node in accordance with embodiments;

FIG. 2B is a schematic diagram of a node in accordance with further embodiments; and

FIG. 3 is a flowchart of a decision tree algorithm in accordance with embodiments.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

Embodiments may support improved power efficiency for communication networks through the allocation of UEs to access points. Methods in accordance with embodiments may be executed, for example, each time a UE provides measurements that may potentially trigger a handover and/or on a predetermined periodicity (hourly, for example).

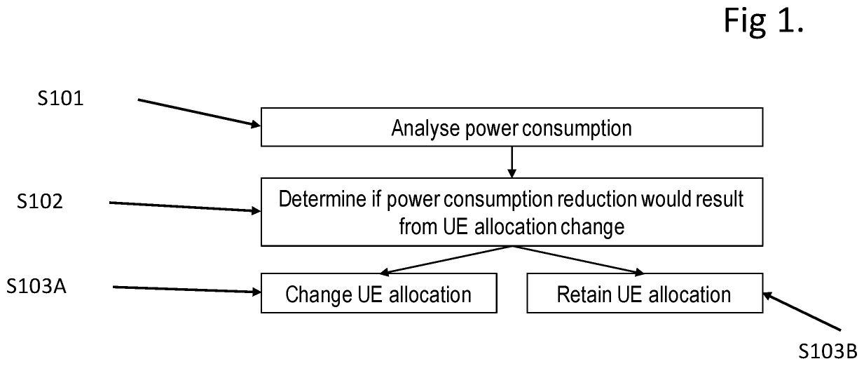

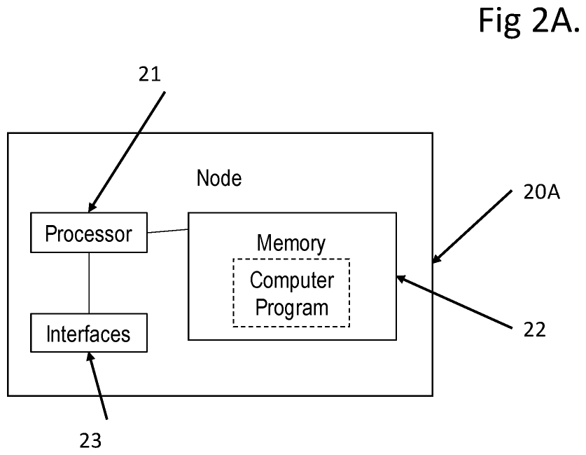

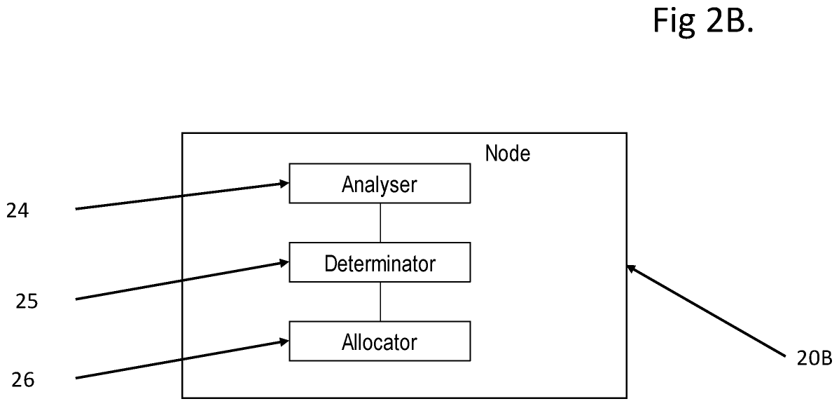

FIG. 1 is a flowchart of a method in accordance with aspects of embodiments. The method may be performed by any suitable apparatus. Examples of suitable apparatus for performing the method shown in FIG. 1 are the nodes 20A and 20B shown schematically in FIG. 2A and FIG. 2B respectively; the nodes 20A and 20B may collectively be referred to using reference sign 20. As discussed above, the method may also be performed by any other suitable component or components, such as a further network component. In some embodiments, the method may be executed in a logical entity (such as a cloud system) distributed across a number of network components such as CNNs and/or RBSs. Although the method may be applied for an entire communications network, it may be more efficient in terms of data management for separate instances of the method to be applied for groups of proximate access nodes, for example, groups of proximate RBSs, particularly where the entire communication network is large. A group of proximate access nodes may be referred to as a neighbourhood of access nodes; the method may be used to control handovers within the neighbourhood. A neighbourhood may comprise a small number of access nodes, by way of example, 10 access nodes. The number of access nodes in a network may be determined based on the specific configuration of the network, taking into account factors such as the number of UEs for which the access points in the neighbourhood provide access, the volumes of data passing through the neighbourhood, and so on.

The node 20A as shown in FIG. 2A may execute steps of the method in accordance with a computer program stored in a memory 22, executed by a processor 21 in conjunction with one or more interfaces 23. The node 20B may execute steps of the method using analyser 24, determinator 25 and allocator 26. The nodes 20A and 20B may also be configured to execute the steps of other aspects of embodiments, as discussed in detail below.

In step S101, the method comprises analysing the power consumption of one or more access nodes in a communication network. In communication networks according to some embodiments, access nodes may support a plurality of different RATs. As an example of this, many 5G RBSs contain Radio Units (RU) that in addition to 5G communications also support 4G communications, Wi-Fi communications, and so on Where a single access node supports multiple RATs, the method may support handovers between RATs provided by the same access node as well as between access nodes. Accordingly, the method may be performed to control handovers for a single access node (for example, between RATs supported by a single RU), as well as for a plurality of access nodes. Different access nodes, and different RAT within an access node supporting more than one RAT, may have different power requirements. Power efficiency may vary with access node model, carrier configuration, which part of a frequency spectrum is used, and so on. In step S101, the power consumption of the access nodes, and of the various RATs supported by the access nodes if applicable, is analysed. The analysis may be based on information received from the access nodes, retrieved from a further network component monitoring the access node power consumption, and/or retrieved from a database. The analysis of the access node power consumption may be performed by node 20A in accordance with a computer program stored in a memory 22, executed by a processor 21, and using information retrieved using interfaces 23. Alternatively, the analysis of the access node power consumption may be performed by node 20B using analyser 24.

In some embodiments, the relevant components of the communication network may be defined using a data structure, stored in a suitable location. Using an example wherein the communication network is a group of neighbouring RBSs in a 3GPP network comprising a plurality of RBSs, a data structure may be maintained and communicated between the RBSs using the X2 protocol. The data structure can be stored in the Neighbour Relations Table (NRT).

An example data structure may be defined as follows. If the neighbourhood in the example comprises k RBSs, the population of the neighbourhood may be defined as POP_{RBS}={RBS1, . . . , RBSk}, wherein each RBS comprises one or more RUs RBSk={RBS_{id}, RU₁, . . . , RU_{y}} and has a population m of UEs attached to it. Additionally, each RBS may be identified by a unique identifier, RBS_{id}. Such identifier can for example be a Cell Global Identity (CGI), consisting of Mobile Country Code (MCC), Mobile Network Code (MNC), Location Area Code (LAC) and Cell Identification (CI), as defied in 3GPP TS 23.003 V17.2.0 3rd Generation Partnership Project; Technical Specification Group Core Network and Terminals; Numbering, addressing and identification; (Release 17), available at https://portal.3gpp.org/desktop modules/Specifications/SpecificationDetails.aspx?specificationId=729 as of 16 Aug. 2021. Each RU in turn comprises one or more ports (that is, antenna ports) each of which can support one or more wireless carriers and a RAT (typically, all carriers for a single port use the same RAT). If/is the number of ports in a RU (RU_{w}), then, for RU_{w}∈RBSk_{RU}, RU_{w}={port₁, . . . , port_{I}}, and for each port t where 1≤t≤I, portₜ={RAT, carrier₁, . . . , carrier_{y}}. Further, each carrier x where 1≤x≤y may be defined as carrierₓ={carrier_{id}, power efficiency, range, bandwidth}, wherein range is the range covered by the carrier (e.g. in radius expressed in m), and is a function of the transmission power used in the carrier, and the bandwidth is the available bandwidth to use based on current usage. Similarly, each carrier has a power efficiency rating, such as milliwatt per Kbit consumed per radio load. Radio load may be described using one or more of the following metrics: aggregate throughput generated by UEs managed by the RU, number of active UE, and power load. Further, the population of UEs attached to a RBS may be defined as RBSk={UERBSk₁, . . . . UERBSkₘ}. Each of the m UEs may support one or more RATs, and has a unique identifier (such as an international mobile subscriber identity, IMSI). Each UE or class of UEs may also have a traffic profile and a mobility profile; traffic and mobility profiles are discussed in greater detail below.

When the power consumption of the one or more access nodes has been analysed, the method then continues with the step of determining, for a UE, whether or not the net power consumption of the communications network would be reduced if the allocation of the UE was changed, as shown in step S102 of FIG. 1. The determination of whether UE allocation change would result in reduced power consumption or not may be performed by node 20A in accordance with a computer program stored in a memory 22, executed by a processor 21, and using information retrieved using interfaces 23. Alternatively, the determination of whether UE allocation change would result in reduced power consumption or not may be performed by node 20B using determinator 25. Where methods are triggered by a UE providing measurements that may potentially trigger a handover, to reduce computational resource usage the handover determination method may be executed in respect of the UE providing the measurements only, or may be triggered in respect of a portion (potentially all) of the UEs connected to the communication network (for example, a portion or all of the UEs connected to the neighbourhood of RBSs).

In some embodiments, the step of determining whether the net power consumption of the network would be reduced if the allocation of the UE was changed comprises estimating power consumption with and without a UE handover, that is, estimating the power consumption if the handover is performed and the power consumption if the handover is not performed. As those skilled in the art will appreciate, the handover process requires signalling; typically signalling between combinations of the UE, the current access node (which the UE is to be handed over from) and/or the new access node (which the UE is to be handed over to). For handovers between RATs provided by the same access node the signalling may be between portions of said access node (and potentially also the UE). The power consumption due to the handover may vary due to the specific communications network configuration, for example, where the handover is between RATs of the same access node and, the power consumption due to the handover may be less than if the handover is between access nodes.

Where the power consumption with and without a UE handover is estimated, this estimate may be obtained using a Machine Learning (ML) model that has been trained to estimate power consumptions due to handovers. Any suitable form of ML model may be used, for example, a neural network (NN) may be suitable for use in most communication networks. To provide accurate estimates, the ML model may be trained using data from one or more access nodes in a communication network, which may be the same communication network as that for which an estimate is to be provided or a different communication network. The training of the ML model may use live data from a communication network (for example, in a reinforcement learning system) or may use cached data from a communication network. In some embodiments, the starting parameter values for the ML model training may be obtained from a further ML model that has been trained in a similar environment; in this way the training process may be shortened.

In some embodiments, the power consumption due to the handover may be represented as a handover index (H_{index}). Taking the example of a handover between RBSs, the energy cost of the handover may include the energy consumption of RU as result of (a) the exchange of messages between the serving RBS and the target RBS (in case the handover is between two neighbouring RBSs and not within the same RBS) and (b) between these RBSs and the UE. Accordingly, the handover index may be given by H_{index}={H_{cost1}, . . . , H_{costX}}, where H_{costX}={Origin_{RBS}_{_{ID}}·carrier_{ID},Destination_RBS_ID·carrier_ID,energy_cost}∀H_{costX}∈H_{index}

Where handover indexes are utilised, the database of handover indexes may be updated following each handover, and this database may be utilised in the training of a ML model to estimate power consumptions due to handovers as discussed above.

In some embodiments, the step of determining whether the net power consumption of the network would be reduced if the allocation of the UE was changed may comprise estimating a traffic profile and/or mobility profile of the UE (or class of UE in the case of traffic profiles, as discussed below). As mentioned in an example above, each UE may have one or both of a traffic profile and mobility profile; where these profiles are available they may be of use in determining whether the net power consumption of the network would be reduced if the allocation of the UE was changed.

The traffic profile may characterise the traffic patterns that the UE exhibits on the downlink and uplink (e.g., using a probability distribution of the throughput over time such as uniform, normal, etc.), allowing future traffic requirements of the UE to be estimated. Therefore, the traffic profile is parameterized by an identifier of the distribution (e.g., its name), and a set of parameters, such as mean (μ) and variance (σ2) for the normal distribution, a and b for uniform distribution, etc. If the traffic profile does not fit a probability distribution, then a formula is given (e.g., an nth degree polynomial) for calculating the throughput over time. In addition or alternatively to calculating traffic profiles for UEs, traffic profiles may be calculated for each class of UEs. Classes of UEs may comprise plural UEs having similar traffic requirements, for example, IoT devices, connected or autonomous vehicles, mobile telephones, and so on. UEs may be grouped into classes in any suitable way, for example, by using the mac addresses of network adapters found in UEs. For reasons of compute optimization, the traffic profile can be aggregated for multiple UEs where the multiple UEs exhibit the same type of traffic behaviour and one model can apply for all of them (e.g., using K-means or other type of clustering). Alternatively, instead of traffic profiling as discussed above, a ML model (such as a neural network) may be used to predict future traffic based on historical traffic patterns (typically, a long-short term memory network, such as a recurrent neural network, may be used for this). The neural network may be trained using data from a plurality of UEs, similarly to the training of the handover power estimate ML model discussed above.

The mobility profile of a UE may indicate the trajectory of the UE and the speed it is moving. From a communications network perspective, mobility can be characterized as a list of <cellID, timestamp> indicating the cell identifier the UE was handed to and at what time (the list can be cyclic so older entries are erased). UE mobility information is typically recorded in the mobile operator via a core network node (CNN) such as a mobility management entity (MME) node in 4G and Access and Mobility Management Function (AMF) in 5G. The mobile network knows the location of each cellID in latitude and longitude, so alternatively mobility can be characterized as a list of <latitude, longitude, timestamp>. Although an exact location of the UE may not be available, the mobility information can provide with a degree of granularity an indication of the general direction the UE is moving towards (e.g., W, SW, E, SE, NW, NE, etc.), which may be used to estimate when subsequent positions of the UE (and access nodes which may therefore be used to provide coverage).

Where a data structure such as the example discussed above is utilised, the step of determining whether or not a power consumption reduction would result from a UE allocation change may be implemented as follows (in this example, the method is implemented for all UEs connected to a neighbourhood of RBSs). Firstly, for every UE connected to an RBS forming part of POP_{RBS}, determine if one or more carriers exist in the UEs serving RBS or in one of its neighbouring RBSs, that fulfils the UE predicted bandwidth requirements (i.e., through the UE traffic profile) and mobility pattern (i.e., through the UE predicted mobility profile). Secondly, for the carriers that fulfil the UE bandwidth and mobility requirements, determine the carrier having the best power efficiency rating. Thirdly, determine if the power efficiency rating of the determined carrier is better than the power efficiency rating of the current carrier. Where the determined carrier has a better power efficiency than the current carrier, the handover energy index may also be utilised to determine if the improvement in power efficiency is negated by the energy cost of the handover or not.

In some embodiments, the step of determining whether the net power consumption of the communications network would be reduced if the allocation of a UE was changed is performed in consideration of the movement of a plurality of UEs at the same time, rather than for a single UE. The number of UEs may be some or all of the UEs hosted by a neighbourhood, for example. Accordingly, the method may comprise determining for the plurality of UEs, whether the net power consumption of the communications network would be reduced if the allocations of the plurality of UEs was changed. The method may therefore be used to help maximise the energy efficiency of the communication network by considering the plurality of UEs as a whole, rather than to maximise the energy efficiency of the communication network by considering each UE individually.

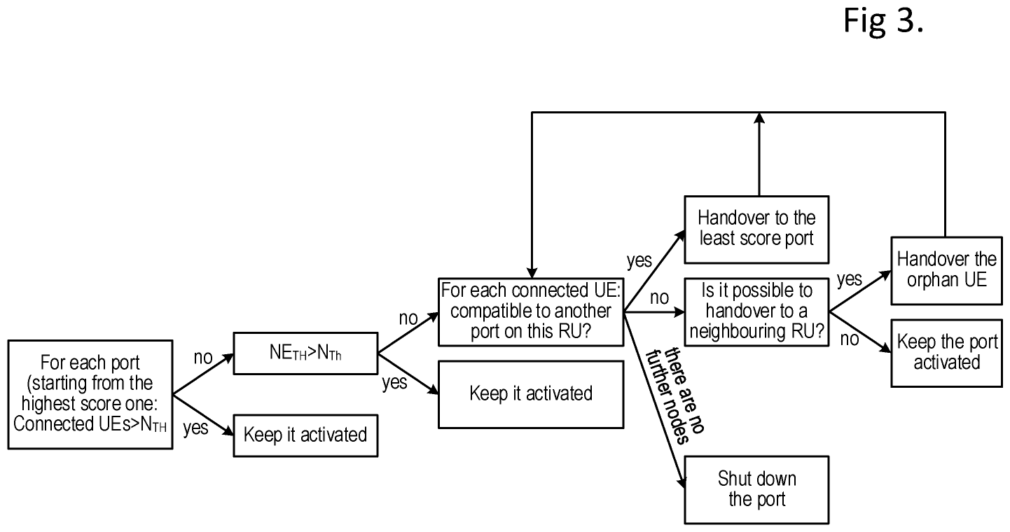

In some situations, handing over a UE to a less energy efficient situation may result in a net improvement of the communication network as a whole. This may be the case where, for example certain RUs have ports with carriers of one or few UEs, where these small numbers of UEs can be transferred to less energy efficient ports with the benefit of allowing the existing ports to be shut down. In some embodiments, in order to assist in the determination for a plurality of UEs, a score for each port may be defined that reflects the potential of the port for being shut down (where a higher score equates to a higher probability of being shut down). In the definition of the score, several aspects like (i) the number of connected UEs, (ii) the ongoing service types, and (iii) the relative energy efficiency of the port at the given load may be considered. As an example of this, a port score for ports providing IoT and Mobile BroadBand (MBB) connections may be defined as Score=F [symbol] N_{UE}, {IoT_{N1}, MBB_{N2}}, 85% [symbol] . Using scores calculated in this way, a predetermined set of rules (as encapsulated, for example, by a decision tree algorithm as shown in the flowchart of FIG. 3) may be used to determine for each port of a RU whether to shut down the port or not, starting from the highest score port. In FIG. 3, N_{Th} is the threshold number of UEs connected to a port, at or below which the algorithm determines whether the UEs may be moved to another port such that the port may be shut down. Similarly, NE_{Th} is the threshold expected number of UEs connected to a port (following planned handovers of UEs), at or below which the algorithm determines whether the UEs may be moved to another port such that the port may be shut down.

The example decision tree algorithm shown in FIG. 3 tries to shut down as many ports as possible by finding underutilized ports that are not critical for UEs. The exact form of the score calculation formula and the weights of different items in the scoring formula may be adjusted depending on the specific communications network configuration. In some embodiments a ML model may be trained to derive the score, and also to recommend potential handover actions, using information on the state of the ports and the upcoming actions taken by the management entity.

Table 1 shows an example of how the decision tree algorithm in FIG. 3 may be utilised to determine whether or not to handover UEs connected to two ports of a RU (here, ports 2 and 5 of the RU).

TABLE 1

| | | | Energy | | |
|---|---|---|---|---|---|
| Active | | | saving | Shut down | |
| port | Connected | | (relative to | score (out | Recommended |
| number | UEs | Service | the best) | of 10) | action |
| 2 | 7 | 2 IoT, | 70% | 3 | Keep active. |
| | | 5 NBB | | | |
| 5 | 11 | 4 IoT, | 60% | 7 | Transfer IoT |
| | | 7 NBB | | | devices to |
| | | | | | port 2. |

When a determination for one or a plurality of UEs as to whether the net power consumption of the communications network would be reduced if the allocation of the UE(s) was changed has been made, the method continues as shown in steps S103A and S103B. If it is determined that the net power consumption of the communications network would be reduced if the allocation of the UE(s) was changed, the allocation of the one or plurality of UEs are changed as shown in step S103A. Alternatively, if it is determined that the net power consumption of the communications network would not be reduced if the allocation of the UE(s) was changed, the allocation of the one or plurality of UEs are retained as shown in step S103B. The allocation change or retention for the one or a plurality of UEs may be performed by node 20A in accordance with a computer program stored in a memory 22, executed by a processor 21, and using information retrieved using interfaces 23. Alternatively, the allocation change or retention for the one or a plurality of UEs may be performed by node 20B using allocator 26.

Where the allocation of the UE (or of plural UEs) is changed, this may comprise allocating the UE to a different access node and/or allocating the UE to a different radio access technology, RAT. Where a UE is allocated to a different RAT, this allocation may be within the same access node or a different access node. In addition to determining the allocation of the one or more UEs, the method may also comprise executing the handover(s) as determined. As will be appreciated by those skilled in the art, the exact steps required for a handover are dependent on the properties of the communication network, access node configurations, RATs used, and so on.

The allocation of UEs may result in some access nodes (or parts of access nodes, such as ports) becoming unused as discussed above. Embodiments may further comprise deactivating unused access nodes or parts of access nodes (such as ports) following the handovers of UEs.

As discussed above, methods in accordance with embodiments may be executed each time UE in the communications network provides measurements that may trigger a handover, and/or with a predetermined periodicity. Accordingly, substantial numbers of UE handovers may be performed or not performed as a result of determinations made in accordance with embodiments. Embodiments may rely on estimations of, for example, UE mobility profiles, traffic profiles, and so on. Where unforeseen/external circumstances result in one or more UEs changing their mobility profiles or traffic profiles in such way that has not been observed before, the estimations may be inaccurate. Inaccurate estimations may also result from other causes, for example, where ML models are used said ML models may have been insufficiently trained or trained using a data set that does not accurately represent current communication network circumstances. A result from inaccurate estimations may be UE handover determinations that result in negative outcomes, such as handing over UEs to suboptimal wireless carriers and/or turning off ports causing UE connection loss or termination of existing data sessions. In order to prevent ongoing issues resulting from UE handover determinations that result in negative outcomes, embodiments may comprise a fallback mechanism.

In order to implement the fallback mechanism, a further determination may be made as to whether controlling the UE allocation based on the determined effect on the net power consumption of the communications network has resulted in a negative outcome (such as UE connection loss or termination of existing UE data sessions). When it is determined that negative outcomes have occurred above a predetermined frequency, embodiments may cease control of the UE allocation based on the determined effect on the net power consumption of the communications network, and may instead utilise a further method to determine UE handovers. The further method may be any existing established method for handover determinations. An investigation may then be undertaken to establish the cause of the negative outcomes, such that UE allocation based on the determined effect on the net power consumption of the communications network may be resumed.

Where a fallback mechanism is implemented, in embodiments this mechanism may rely on a prediction entropy metric; a metric which may be decremented each time a UE handover decision results in a net reduction in the communication network energy consumption (for brevity, referred to herein as a positive result). The metric may be incremented each time a UE handover decision results in a net increase in the communication network energy consumption, or results in a negative outcome such as connection loss as discussed above. The sizes of the increments and decrements are not necessarily equal, for example, a connection loss may result in a larger increment to the metric than an increase in communication network energy consumption. If the net value of the metric increases above a predetermined threshold, this may then trigger a cessation of control of the UE allocation based on the determined effect on the net power consumption as discussed above. In some embodiments in which a prediction entropy metric is utilised, a monitoring period may also be utilised in which, following the determinations as to whether or not one or more UEs should be handed over but prior to any determined handovers taking place, the energy consumption of the communications network and selected key performance indicators (KPIs) that are indicative of negative outcomes are also monitored. The use of a monitoring period in this way may improve the accuracy of the prediction entropy metric, by helping to avoid negative outcomes (such as connection losses) not resulting from UE handover determinations being incorrectly attributed to the UE handover determinations.

Embodiments allow the energy consumption of access nodes to be taken into consideration when making handover decisions for UEs, potentially in addition to other factors (such as UE quality of service, UE energy usage, and so on). Accordingly, embodiments may allow the energy consumption of communications networks to be reduced relative to prior systems. Embodiments may also consider the possibility of moving UEs between access nodes and/or between RATs to allow the shutting down part or all of one or more access nodes, thereby supporting further energy consumption reductions of the access nodes. Embodiments may be implemented using existing technology and interfaces (such as X2 interfaces in 3GPP networks), thereby reducing the modifications required to implement embodiments.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A method for allocation of User Equipments, UEs, in a communications network comprising one or more access nodes, the method comprising:
analysing the power consumption of the one or more access nodes;
determining, for a UE, whether the net power consumption of the communications network would be reduced if the allocation of the UE was changed; and
if it is determined that the net power consumption of the communications network would be reduced if the allocation of the UE was changed, changing the UE allocation; or
if it is determined that the net power consumption of the communications network would not be reduced if the allocation of the UE was changed, retaining the current UE allocation.

2. The method of claim 1, wherein changing the allocation of the UE comprises allocating the UE to a different access node and/or allocating the UE to a different radio access technology, RAT.

3. The method of claim 1, wherein the changing of the UE allocation comprises executing a handover from the current UE allocation to the new UE allocation.

4. The method of claim 3, wherein the determination of whether or not the net power consumption of the communications network would be reduced if the allocation of the UE was changed comprises estimating the power consumption due to the handover, the estimate comprising estimating the power consumption if the handover is performed, and estimating the power consumption if the handover is not performed.

5. The method of claim 4, wherein the power consumption due to the handover is estimated using a Machine Learning, ML, model that has been trained to estimate power consumptions due to handovers.

6. The method of claim 5, wherein the ML model is a neural network.

7. The method of claim 5, wherein the ML model is trained using data from the one or more access nodes.

8. The method of claim 1, wherein the determination of whether or not the net power consumption of the communications network would be reduced if the allocation of the UE was changed comprises estimating a traffic profile of the UE and/or a traffic profile of the class of UE and/or a mobility profile of the UE.

9. The method of claim 8, wherein the traffic profile of the UE and/or of the class of UE is estimated using a further Machine Learning, ML, model that has been trained to estimate traffic profiles of UEs and/or traffic profiles of classes of UEs.

10. The method of claim 9, wherein the further ML model is a neural network.

11. The method of claim 9, wherein the further ML model is trained using data from a plurality of UEs.

12. The method of claim 8, wherein the mobility profile of the UE is obtained from a Core Network Node, CNN, of the communications network.

13. The method of claim 1, wherein the method is repeated each time a UE in the communications network provides measurements that may trigger a handover.

14.-16. (canceled)

17. The method of claim 1, wherein:
the method determines, for a plurality of UEs, whether the net power consumption of the communications network would be reduced if the allocations of the plurality of UEs was changed; and
if it is determined that the net power consumption of the communications network would be reduced if the allocation of the plurality of UEs was changed, the allocation of the plurality of UEs is changed.

18. The method of claim 1, further comprising determining whether controlling the UE allocation based on the determined effect on the net power consumption of the communications network has resulted in a negative outcome.

19. The method of claim 18, wherein the negative outcome comprises one or more of UE connection loss and termination of existing UE data sessions.

20. The method of claim 18 further comprising, if it is determined that negative outcomes have occurred above a predetermined frequency, ceasing control of the UE allocation based on the determined effect on the net power consumption of the communications network.

21. (canceled)

22. A node for allocation of User Equipments, UEs, in a communications network comprising one or more access nodes, wherein the node comprises processing circuitry and a memory containing instructions executable by the processing circuitry, whereby the node is operable to:
analyse the power consumption of the one or more access nodes;
determine, for a UE, whether the net power consumption of the communications network would be reduced if the allocation of the UE was changed; and
if it is determined that the net power consumption of the communications network would be reduced if the allocation of the UE was changed, change the UE allocation; or
if it is determined that the net power consumption of the communications network would not be reduced if the allocation of the UE was changed, retain the current UE allocation.

23.-42. (canceled)

43. A node for allocation of User Equipments, UE, in a communications network comprising one or more access nodes, wherein the node comprises:
an analyser configured to analyse the power consumption of the one or more access nodes;
a determinator configured to determine, for a UE, whether the net power consumption of the communications network would be reduced if the allocation of the UE was changed; and
an allocator configured to:
if it is determined that the net power consumption of the communications network would be reduced if the allocation of the UE was changed, change the UE allocation; or
if it is determined that the net power consumption of the communications network would not be reduced if the allocation of the UE was changed, retain the current UE allocation.

44. A computer program product comprising a non-transitory computer-readable medium comprising instructions which, when executed on processing circuitry, cause the processing circuitry to perform the method according to claim 1.
